(19) United States
(12) Patent Application Publication
(10) Pub. No.: US 2016/0299641 A1
(43) Pub. Date: Oct. 13, 2016

(54) User Interface for Social Interactions on a Head-Mountable Display

(71) Applicant: Google Inc., Mountain View, CA (US)

(72) Inventors: Michael J. LEBEAU, New York, NY (US); Mathieu BALEZ, San Francisco, CA (US); Richard THE, New York, NY (US)

(73) Assignee: Google Inc., Mountain View, CA (US)

(21) Appl. No.: 13/854,799

(22) Filed: Apr. 1, 2013

(51) Int. Cl. G06F 3/0482

(52) U.S. Cl. CPC G06F 3/0482

(57) ABSTRACT

Methods, apparatuses, and computer-readable media are described herein related to a user interface and interactions for a head-mountable device. An HMD can display a first interaction screen of an ordered plurality of interaction screens. The first interaction screen may include information corresponding to a first interaction associated with a contact of the HMD. While displaying the first interaction screen, the HMD can receive an input at the HMD. The input may be associated with the contact and comprises a second interaction. The HMD can also associate a second interaction screen with the ordered plurality of interaction screens. The second interaction screen may include information corresponding to the second interaction. The HMD can further display the second interaction screen using the HMD.

### BACKGROUND

Unless otherwise indicated herein, the materials described in this section are not prior art to the claims in this application and are not admitted to be prior art by inclusion in this section.

Computing systems such as personal computers, laptop computers, tablet computers, cellular phones, and countless types of Internet-capable devices are prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called “head-mounted displays” (HMDs). A head-mounted display places a graphic display or displays close to one or both eyes of a wearer. To generate the images on a display, a computer processing system may be used. Such displays may occupy part or all of a wearer's field of view. Further, head-mounted displays may be as small as a pair of glasses or as large as a helmet.

### SUMMARY

In one aspect, a method is provided. The method includes displaying, at a head-mountable device (HMD), a first interaction screen of an ordered plurality of interaction screens. The first interaction screen may include information corresponding to a first interaction associated with a contact of the HMD, the ordered plurality of interaction screens may be indicative of an interaction history associated with the contact, and the ordered plurality of interaction screens may be navigable in a linear fashion. The method also includes, while displaying the first interaction screen, receiving an input at the HMD. The input may be associated with the contact and may include a second interaction. The second interaction may be different than the first interaction. The method additionally includes associating a second interaction screen with the ordered plurality of interaction screens. The second interaction screen may include information corresponding to the second interaction, the first interaction screen may be subsequent to the second interaction screen in the ordered plurality of interaction screens, and the second interaction may be indicative of a most recent interaction in the interaction history. The method further includes displaying the second interaction screen using the HMD.

In another aspect, an HMD is provided. The HMD includes a display, a processor, and a non-transitory computer-readable storage medium having stored thereon program instructions. The program instructions, upon execution by the processor, cause the HMD to perform functions including displaying a first interaction screen of an ordered plurality of interaction screens. The first interaction screen may include information corresponding to a first interaction associated with a contact of the HMD, the ordered plurality of interaction screens may be indicative of an interaction history associated with the contact, and the ordered plurality of interaction screens may be navigable in a linear fashion. The functions also include, while displaying the first interaction screen, receiving an input at the HMD. The input may be associated with the contact and may include a second interaction. The second interaction may be different than the first interaction. The functions additionally include associating a second interaction screen with the ordered plurality of interaction screens. The second interaction screen may comprise information corresponding to the second interaction, the first interaction screen may be subsequent to the second interaction screen in the ordered plurality of interaction screens, and the second interaction may be indicative of a most recent interaction in the interaction history. The functions further include displaying the second interaction screen using the HMD.

In a further aspect, an apparatus is provided. The apparatus includes a non-transitory computer-readable storage medium having stored thereon program instructions. The program instructions, upon execution by a computing device, cause the apparatus to perform functions including displaying a first interaction screen of an ordered plurality of interaction screens. The first interaction screen may include information corresponding to a first interaction associated with a contact of the HMD, the ordered plurality of interaction screens may be indicative of an interaction history associated with the contact, and the ordered plurality of interaction screens may be navigable in a linear fashion. The functions also include, while displaying the first interaction screen, receiving an input at the HMD. The input may be associated with the contact and include a second interaction. The second interaction may be different than the first interaction. The functions additionally include associating a second interaction screen with the ordered plurality of interaction screens. The second interaction screen may comprise information corresponding to the second interaction, the first interaction screen may be subsequent to the second interaction screen in the ordered plurality of interaction screens, and the second interaction may be indicative of a most recent interaction in the interaction history. The functions further include displaying the second interaction screen using the HMD.

In yet another aspect a system is disclosed. The system includes a means for displaying, at a head-mountable device (HMD), a first interaction screen of an ordered plurality of interaction screens. The first interaction screen may include information corresponding to a first interaction associated with a contact of the HMD, the ordered plurality of interaction screens may be indicative of an interaction history associated with the contact, and the ordered plurality of interaction screens may be navigable in a linear fashion. The system also includes a means for, while displaying the first interaction screen, receiving an input at the HMD. The input may be associated with the contact and may include a second interaction. The second interaction may be different than the first interaction. The system additionally includes a means for associating a second interaction screen with the ordered plurality of interaction screens. The second interaction screen may include information corresponding to the second interaction, the first interaction screen may be subsequent to the second interaction screen in the ordered plurality of interaction screens, and the second interaction may be indicative of a most recent interaction in the interaction history. The system further includes a means for displaying the second interaction screen using the HMD.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrative embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A illustrates a wearable computing system, according to an example embodiment.

FIG. 1B illustrates an alternate view of the wearable computing device illustrated in FIG. 1A.

FIG. 1C illustrates another wearable computing system, according to an example embodiment.

FIG. 1D illustrates another wearable computing system, according to an example embodiment.

FIGS. 1E to 1G are simplified illustrations of the wearable computing system shown in FIG. 1D, being worn by a wearer.

FIG. 2A illustrates a schematic drawing of a computing device, according to an example embodiment.

FIG. 2B shows an example device coordinate system and an example display coordinate system, according to an example embodiment.

FIG. 3 shows an example home card of an example UI for a HMD, according to an example embodiment.

FIG. 4 shows example operations of a multi-tiered user model for a UI for a HMD, according to an example embodiment.

FIG. 5A shows an example interaction card of an example UI for an HMD, according to an example embodiment.

FIG. 5B shows a scenario of timeline interactions, according to an example embodiment.

FIG. 5C shows another scenario of timeline interactions, according to an example embodiment.

FIG. 5D shows another scenario of timeline interactions, according to an example embodiment.

FIG. 5E shows another scenario of timeline interactions, according to an example embodiment.

FIG. 6A is a flow chart illustrating a method, according to an example embodiment.

FIG. 6B is another flow chart illustrating a method, according to an example embodiment.

### DETAILED DESCRIPTION

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### A. OVERVIEW

In an example embodiment, a user-interface (UI) for an HMD may include a timeline feature that allows the wearer to navigate through a sequence of ordered screens. In the context of such a timeline feature, each screen may be referred to as a “card.” Among the sequence of cards, one or more cards may be displayed, and of the displayed card(s), one card may be “focused on” for possible selection. For example, the timeline may be present one card for display at a time, and the card being displayed is also the card being focused on. In one embodiment, when a card is selected, the card may be displayed using a single-card view that occupies substantially all of the viewing area of the display.

Each card may be associated with a certain application, object, or operation. The cards may be ordered by a time associated with the card, application, object or operation represented by the card. For example, if a card shows a photo captured by a wearer of the HMD at 2:57 PM, the time associated with the card is the time associate with the underlying photo object of 2:57 PM. As another example, a card representing a weather application may be continuously updating temperature, forecast, wind, and other weather-related information, and as such, the time associated with the weather application may be the current time. As an additional example, a card representing a calendar application may show a next appointment in 2 hours from now, and so the time associated with the card may be a time corresponding to the displayed next appointment, or 2 hours in the future.

The timeline feature may allow the wearer to navigate through the cards according to their associated times. For example, a wearer could move their head to the left to navigate to cards with times prior to a time associated with the focused-on card, and to the right to navigate to cards with times after the time associated with the focused-on card. As another example, the wearer may use a touch pad or similar device as part of a touch-based UI to make a swiping motion in one direction on the touch-based UI to navigate to cards with times prior to the time associated with the focused-on card, and make a swiping motion in another direction to navigate to cards with times after the time associated with the focused-on card. After viewing cards on the timeline, the wearer may choose to interact with some cards.

Upon power up, the HMD may display a “home card”, also referred to as a home screen. The home card may display a clock, and be associated with a time of “now” or a current time. In some cases, the home card may display a clock, to reinforce the association between the home card and now. Then, cards associated with times before now may be viewed in the timeline as prior to the home card, and cards associated with times equal to or after now may be viewed in the timeline subsequent to the home card.

In other embodiments, upon receiving inputs associated with certain objects or applications, the HMD may display related cards or screens. For example, a plurality of cards may represent a history of communication between the wearer of an HMD and a contact of the HMD. For instance, if a wearer of the HMD desires to communicate with a contact in real-time, the wearer may initiate a phone call with a contact associated with the HMD. Upon initiation of the phone call, the HMD may initiate and display an interaction card or screen representing the interaction between the wearer of the HMD and contact. As the wearer and the contact continue to interact using various means of communication, a new card may be initiated and added to a timeline indicative of a history of communication between the wearer of the HMD and the contact. Over time, each card may represent a portion of the communication and may be appended to the timeline.

For example, upon receiving an interaction such as a text message from a contact of the HMD, the wearer may be presented with in “interaction card,” also referred to as an interaction screen. The interaction card may display a representation of the contact that includes an icon representing a picture of the contact or a picture that was previously chosen to represent the contact. The interaction card may also include the text message. In some cases, the interaction may include a clock or time stamp that associates the interaction with the time upon which the interaction occurred. Other indicators and descriptors may be included in the interaction screen as well.

Upon receiving another interaction initiated by the contact, or upon the wearer responding to the first interaction, the user may be presented with another interaction screen that displays a representation of the current interaction. If for example, the user of the HMD, attempted to call the contact by telephone (e.g., in response to the text message), the interaction card may display indicators indicating a telephone call attempt was made, along with the picture of the contact and the time stamp, for example. The additional interaction screen may be added to the timeline in a manner that allows the additional interaction card to be viewed in the time line as subsequent to the first interaction card, and may represent the most recent interaction between the wearer of the HMD and the contact.

In some cases, for example upon a lapse of time, a final interaction card may be displayed that represents the end of communication between the user of the HMD and a particular contact. For example, if the user of the HMD does not initiate an interaction with the particular contact nor receive an interaction from the contact for a period of five minutes, an interaction card may be displayed that consummates the interactions. In some cases, the last interaction card may include the last interaction between the wearer of the HMD and the contact, and in other cases may include a summary of communication between the wearer of the HMD and the contact. Alternatively, in other cases, the end of a timeline of interaction cards may be triggered by a change of date. In other words, the user may be presented with communication timeline(s) based upon the time(s) when the interaction was received.

After viewing the cards on the communication (or interaction) timeline, the wearer can choose to interact with one or more interaction cards. To select a card on the timeline for interaction, the wearer can tap on the touch-based UI, also referred to as performing a “tap operation,” to select a focused-on-card. In some cases the focused-on card may be used as a starting point to further interact with the contact associated with the interaction card. In other examples, the focused-on-card may simply be used to refer back to a previous interaction.

By organizing operations such as interactions and/or communications between an operator of an HMD and, for example, contact of the HMD into interaction cards, the UI may provide a relatively simple interface to a timeline representing a communication history. Further, by enabling operation on a collection of cards in a natural fashion—according to time in one example—the wearer may readily locate and utilize cards or screens that define the communication history and may thereby experience a more realistic real-time communication experience.

### B. EXAMPLE WEARABLE COMPUTING DEVICES

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device (HMD).

An example system may also be implemented in or take the form of other devices, such as a mobile phone, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

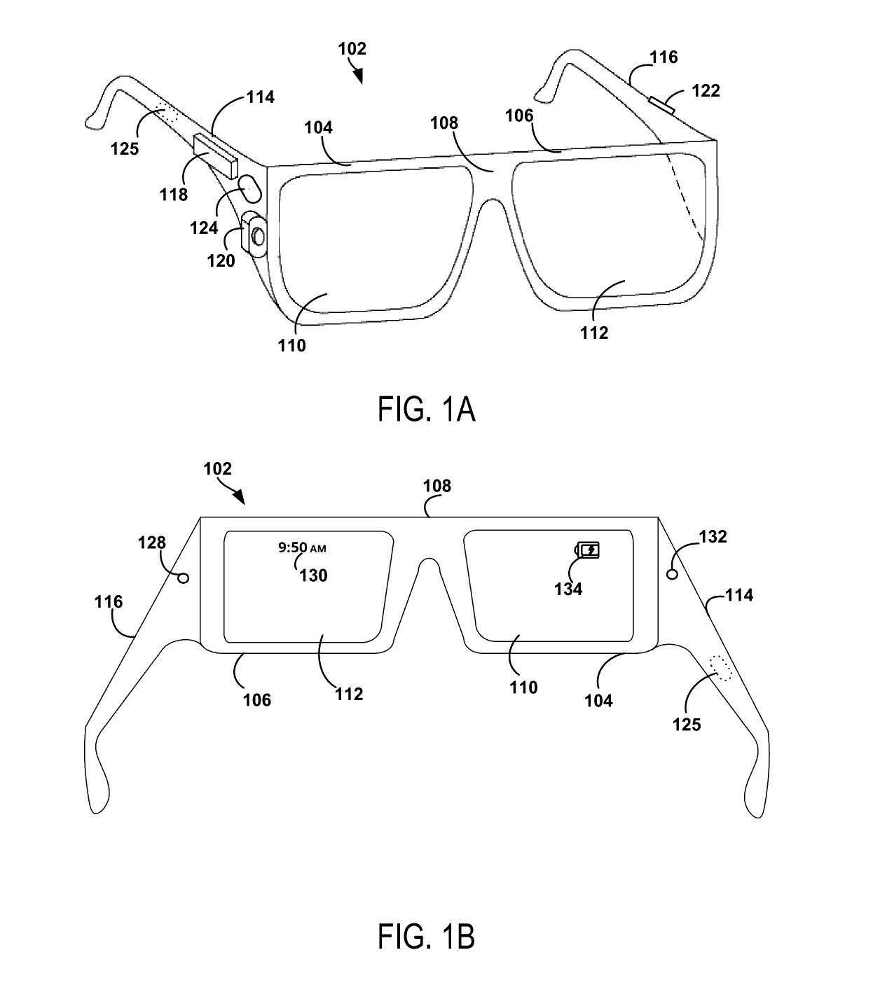

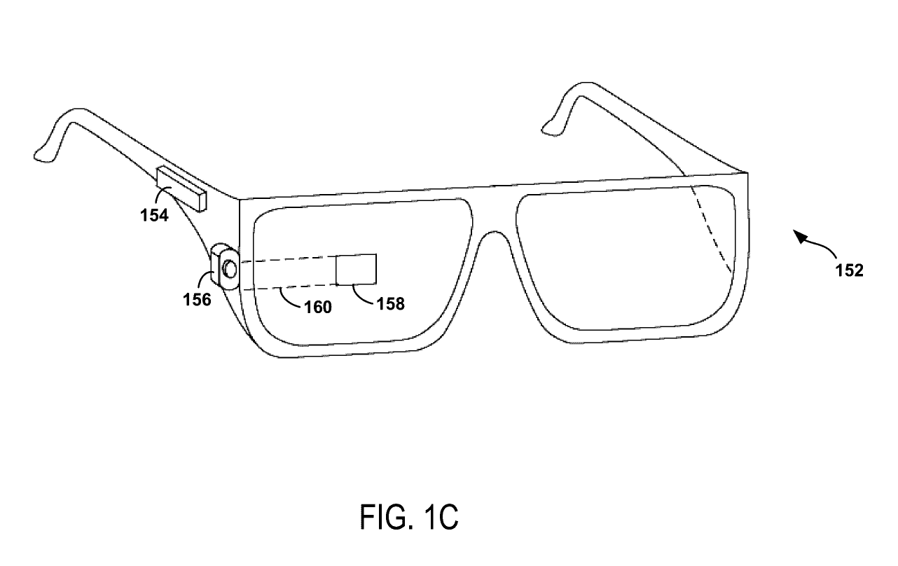

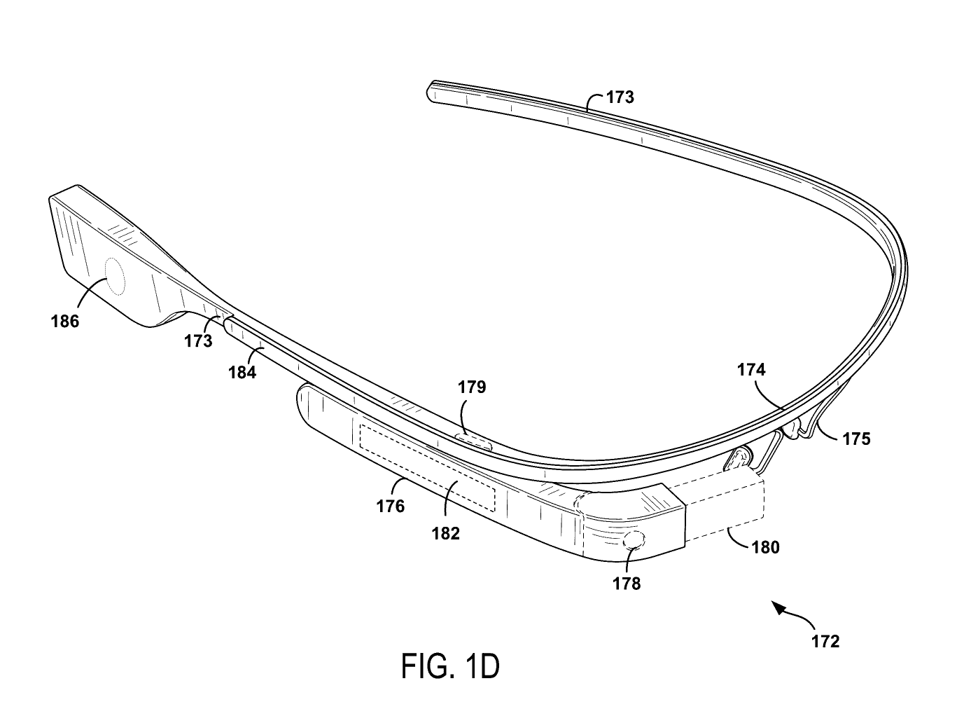

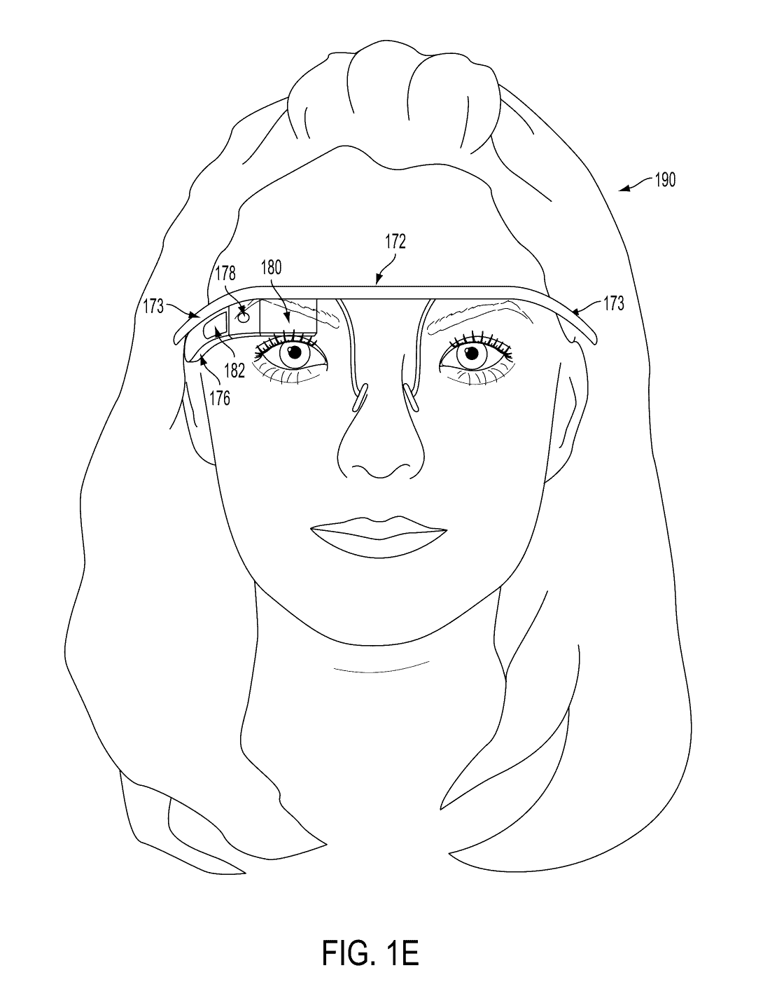

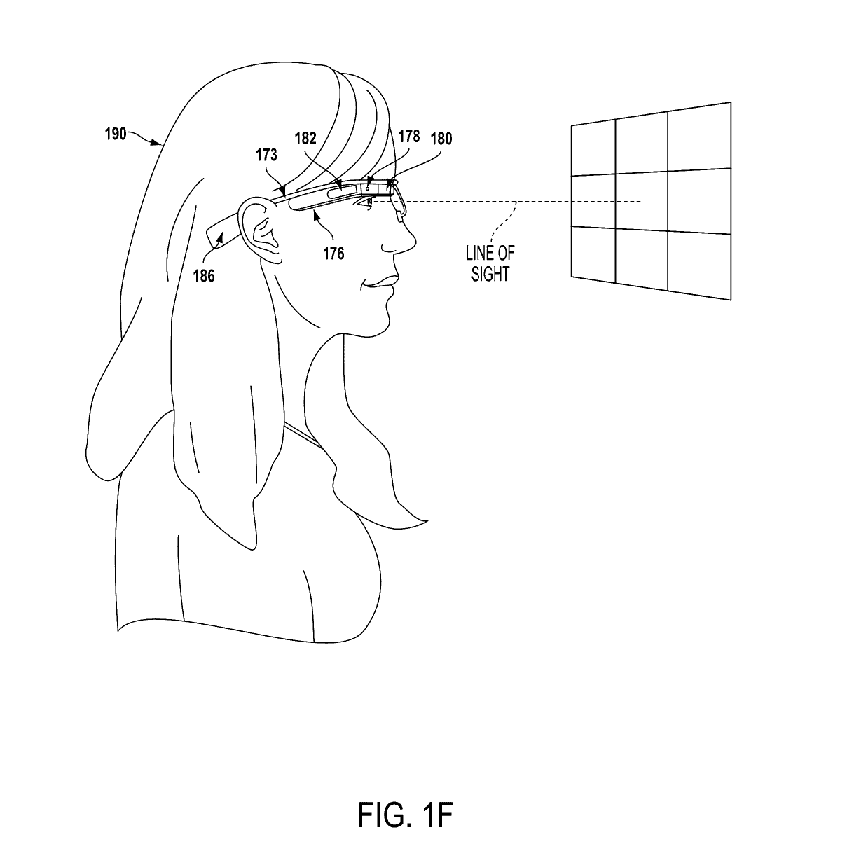

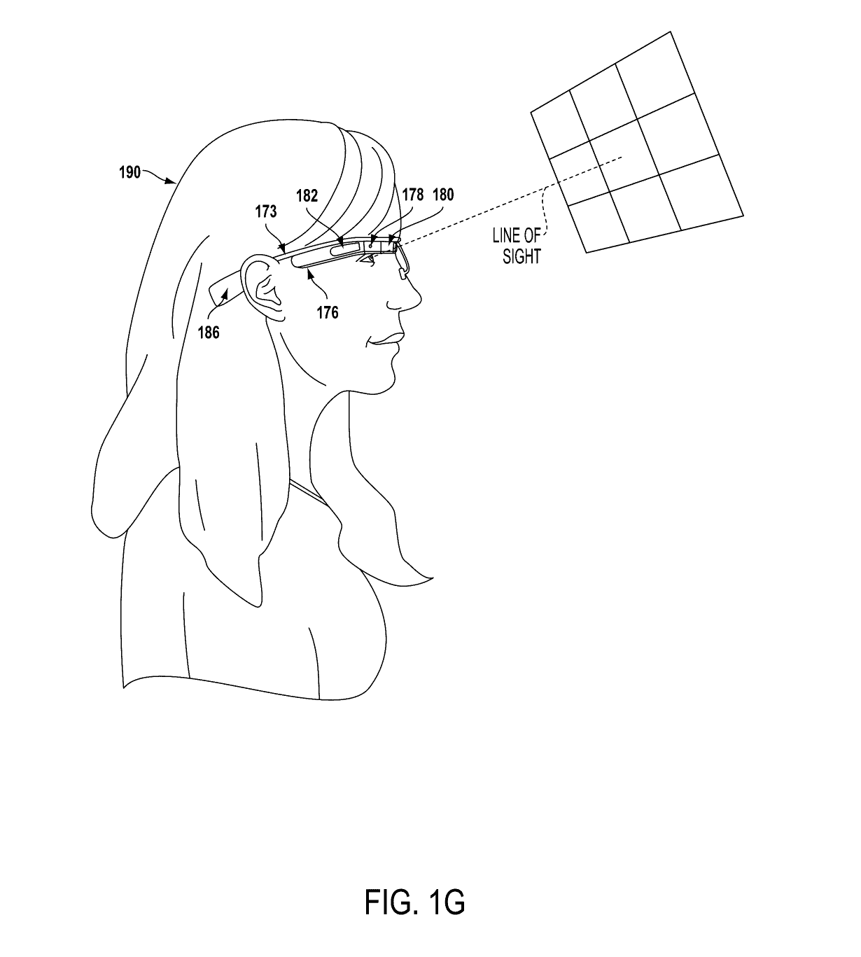

FIG. 1A illustrates a wearable computing system according to an example embodiment. In FIG. 1A, the wearable computing system takes the form of a head-mountable device (HMD) 102 (which may also be referred to as a head-mounted display). It should be understood, however, that example systems and devices may take the form of or be implemented within or in association with other types of devices, without departing from the scope of the invention. As illustrated in FIG. 1A, the HMD 102 includes frame elements including lens-frames 104, 106 and a center frame support 108, lens elements 110, 112, and extending side-arms 114, 116. The center frame support 108 and the extending side-arms 114, 116 are configured to secure the HMD 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the HMD 102 to the user. The extending side-arms 114, 116 may further secure the HMD 102 to the user by extending around a rear portion of the user's head. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touch pad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touch pad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. The image capture device 120 may be configured to capture images at various resolutions or at different frame rates. Many image capture devices with a small form-factor, such as the cameras used in mobile phones or webcams, for example, may be incorporated into an example of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user.

The sensor 122 is shown on the extending side-arm 116 of the HMD 102; however, the sensor 122 may be positioned on other parts of the HMD 102. For illustrative purposes, only one sensor 122 is shown. However, in an example embodiment, the HMD 102 may include multiple sensors. For example, an HMD 102 may include sensors 102 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 124 is shown on the extending side-arm 114 of the HMD 102. However, the finger-operable touch pad 124 may be positioned on other parts of the HMD 102. Also, more than one finger-operable touch pad may be present on the HMD 102. The finger-operable touch pad 124 may be used by a user to input commands. The finger-operable touch pad 124 may sense at least one of a pressure, position and/or a movement of one or more fingers via capacitive sensing, resistance sensing, or a surface acoustic wave process, among other possibilities. The finger-operable touch pad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

In a further aspect, HMD 102 may be configured to receive user input in various ways, in addition or in the alternative to user input received via finger-operable touch pad 124. For example, on-board computing system 118 may implement a speech-to-text process and utilize a syntax that maps certain spoken commands to certain actions. In addition, HMD 102 may include one or more microphones via which a wearer's speech may be captured. Configured as such, HMD 102 may be operable to detect spoken commands and carry out various computing functions that correspond to the spoken commands.

As another example, HMD 102 may interpret certain head-movements as user input. For example, when HMD 102 is worn, HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, HMD 102 may interpret certain gestures (e.g., by a wearer's hand or hands) as user input. For example, HMD 102 may capture hand movements by analyzing image data from image capture device 120, and initiate actions that are defined as corresponding to certain hand movements.

As a further example, HMD 102 may interpret eye movement as user input. In particular, HMD 102 may include one or more inward-facing image capture devices and/or one or more other inward-facing sensors (not shown) that may be used to track eye movements and/or determine the direction of a wearer's gaze. As such, certain eye movements may be mapped to certain actions. For example, certain actions may be defined as corresponding to movement of the eye in a certain direction, a blink, and/or a wink, among other possibilities.

HMD 102 also includes a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of HMD 102 may be designed such that when a user wears HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions, such as for example towards either the upper or lower portions of the wearer's field of view. The display 158 is controllable via the computing system 154 that is coupled to the display 158 via an optical waveguide 160.

FIG. 1D illustrates another wearable computing system according to an example embodiment, which takes the form of a monocular HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD. HMD 172 also includes a BCT 186.

The HMD 172 may include a single display 180, which may be coupled to one of the side-arms 173 via the component housing 176. In an example embodiment, the display 180 may be a see-through display, which is made of glass and/or another transparent or translucent material, such that the wearer can see their environment through the display 180. Further, the component housing 176 may include the light sources (not shown) for the display 180 and/or optical elements (not shown) to direct light from the light sources to the display 180. As such, display 180 may include optical features that direct light that is generated by such light sources towards the wearer's eye, when HMD 172 is being worn.

In a further aspect, HMD 172 may include a sliding feature 184, which may be used to adjust the length of the side-arms 173. Thus, sliding feature 184 may be used to adjust the fit of HMD 172. Further, an HMD may include other features that allow a wearer to adjust the fit of the HMD, without departing from the scope of the invention.

FIGS. 1E to 1G are simplified illustrations of the HMD 172 shown in FIG. 1D, being worn by a wearer 190. As shown in FIG. 1F, when HMD 172 is worn, BCT 186 is arranged such that when HMD 172 is worn, BCT 186 is located behind the wearer's ear. As such, BCT 186 is not visible from the perspective shown in FIG. 1E.

In the illustrated example, the display 180 may be arranged such that when HMD 172 is worn, display 180 is positioned in front of or proximate to a user's eye when the HMD 172 is worn by a user. For example, display 180 may be positioned below the center frame support and above the center of the wearer's eye, as shown in FIG. 1E. Further, in the illustrated configuration, display 180 may be offset from the center of the wearer's eye (e.g., so that the center of display 180 is positioned to the right and above of the center of the wearer's eye, from the wearer's perspective).

Configured as shown in FIGS. 1E to 1G, display 180 may be located in the periphery of the field of view of the wearer 190, when HMD 172 is worn. Thus, as shown by FIG. 1F, when the wearer 190 looks forward, the wearer 190 may see the display 180 with their peripheral vision. As a result, display 180 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 180 is located as shown, the wearer 190 may view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

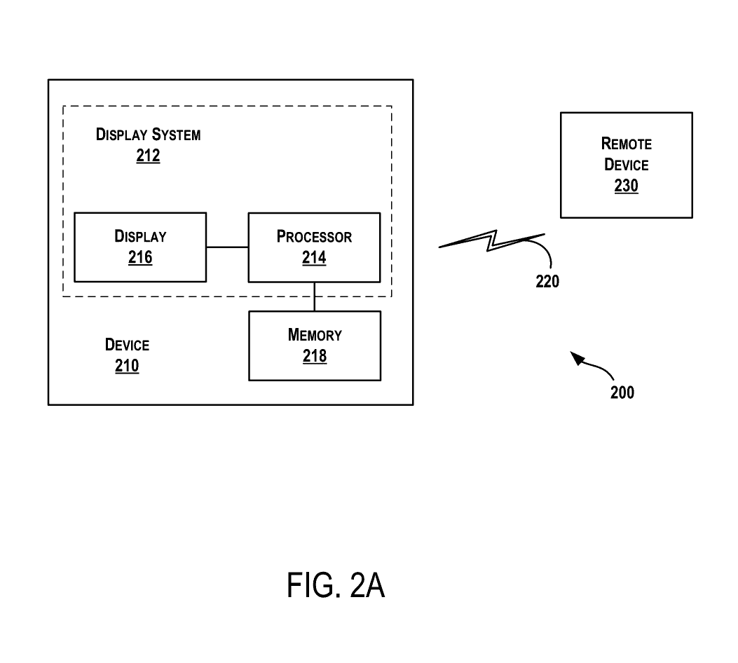

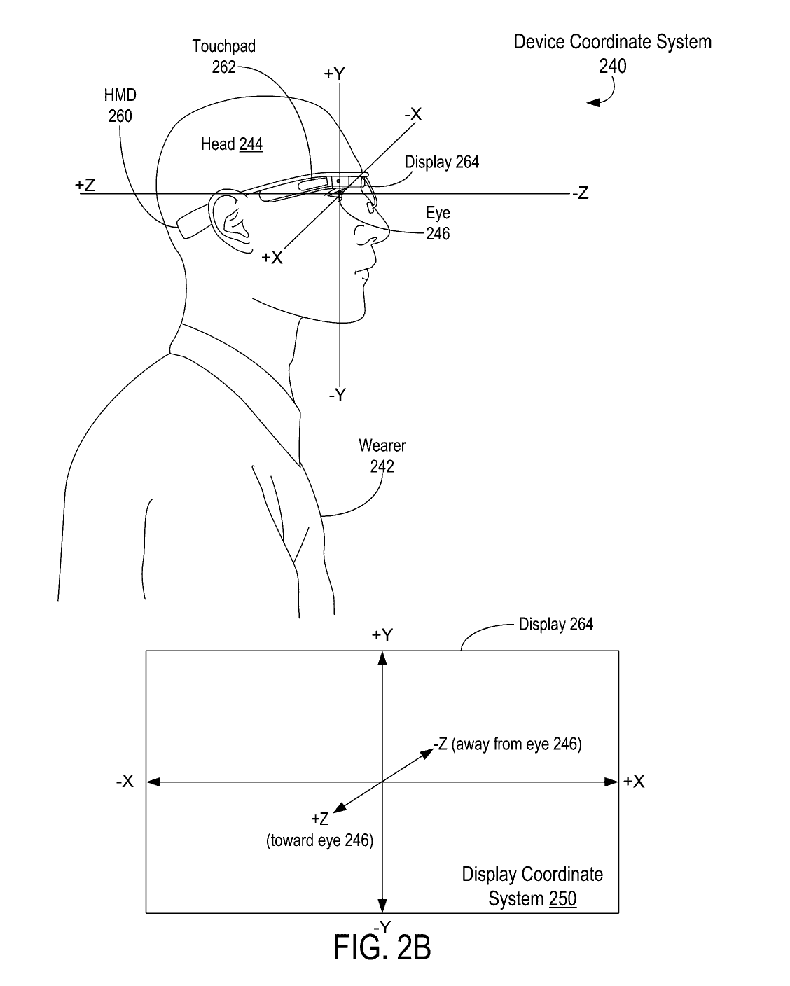

FIG. 2A illustrates a schematic drawing of a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may be a heads-up display system, such as the head-mounted devices 102, 152, or 172 described with reference to FIGS. 1A to 1G.

Thus, the device 210 may include a display system 212 comprising a processor 214 and a display 216. The display 210 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, or tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 2A, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

### C. EXAMPLE COORDINATE SYSTEMS

FIG. 2B shows an example device coordinate system 240 and corresponding display coordinate system 250 in accordance with an embodiment. The device coordinate system 250 is used herein: when HMD 260 is level and upright on head 244 of wearer 242 with display 264 facing eye 246 of wearer 242, as shown in FIG. 2B, +X is right, +Y is up, and +Z is towards eye 246 (with respect to display 264) such that forward is −Z. In Figures showing the YZ plane, +X is toward the reader and −X is away from the reader in device coordinates. In terms of device coordinates, a swipe toward (sometimes termed swipe backward or swipe left) can involve a swipe, or movement by one or more fingers touching the touch pad, in the +Z direction. In device coordinates, a swipe away (sometimes termed swipe forward or swipe right) can involve swiping in the −Z direction.

Device coordinate system 240 can be used to specify a coordinate system for images shown in eye 246 of wearer 242 using display 264. FIG. 2B shows display coordinate system 250 for displaying images using display 264 as viewed by wearer 242. As shown in FIG. 2B, when HMD 260 is level and upright on head 244 with display 264 facing eye 246, +X in device coordinate system 250 is right along display 264, +Y in device coordinate system 250 is up with respect to display 264, and +Z in display coordinate system 250 is towards eye 246. For example, for fixed X and Y components in display coordinate system 250 objects shown on display 264 with a Z component of Z1 can appear to be larger to wearer 242 than objects having a Z component of Z2, where Z1>Z2. That is, as Z coordinates increase in display coordinate system 260, image displayed in display 264 using display coordinate system 250 appear increasingly larger up to the limits of display 264. In some embodiments, a two-dimensional display system can use coordinates of display coordinate system with a fixed Z component; e.g., Z=0. Unless specifically stated otherwise, X, Y, and Z components are specified below using display coordinate system 250.

### D. AN EXAMPLE USER INTERFACE FOR AN HMD

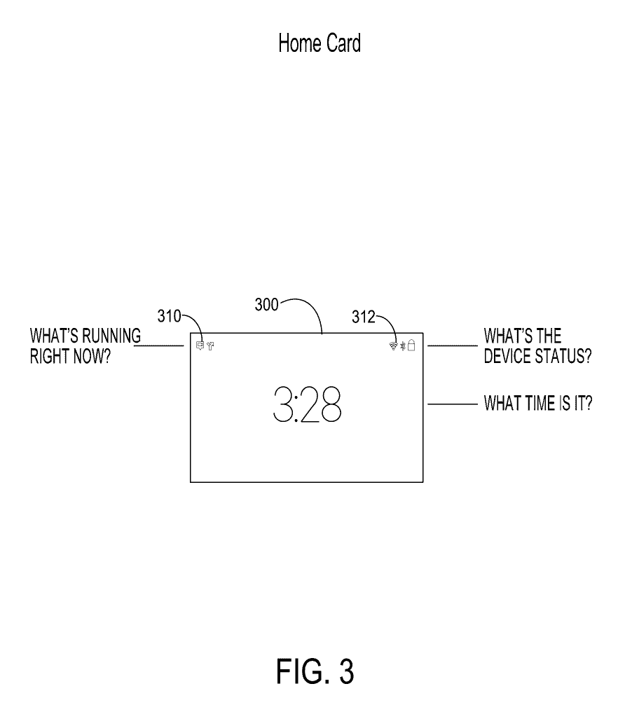

FIGS. 3 through 5 collectively describe aspects of an example user interface for an HMD such as discussed above at least in the context of FIGS. 1A through 2B. The HMD can be configured with a UI controller receiving inputs from at least a touch-based UI. The touch-based UI can include a touch pad and a button, configured to receive various touches, such as one-finger swipes in various directions, two-finger or multi-finger swipes in various directions, taps, button presses of various durations, and button releases. In some embodiments, the HMD can utilize a voice-based UI as well.

In other embodiments, the operations described herein related to the touch-based UI can be performed using additional or other devices. Some examples of additional or other devices include, but are not limited to: optical gesture sensors, non-contact electrostatic gesture sensors, and a magnetometer detecting a moving magnetic field controlled by a wearer; e.g., a ring having a magnetic field being worn and moved by the wearer.

Once a touch is received, the touch-based UI can report the touch; e.g., a “swipe forward” or “tap” to the HMD, or in some cases, to a component of the HMD such as a UI controller. In other embodiments, the HMD can act as the UI controller. As described herein, the HMD includes any necessary components, such as but not limited to one or more UI controllers, which are configured to perform and control the UI operations described herein.

The HMD can generate cards or screens that can occupy the full display of the HMD when selected. One card is a home card that is the first card displayed when the UI is activated, for example shortly after HMD powers up or when the HMD wakes from a sleep or power-saving mode. FIG. 3 shows an example home card 300 of an example user interface, according to an example embodiment. Home card 300 includes application status indicators 310, device status indicators 312, and a clock shown in large numerals indicating the current time in the center of home card 300. Application status indicators 310 can indicate which application(s) are operating on the HMD. As shown in FIG. 3, application status indicators 310 include camera and Y-shaped road icons to respectively indicate operation of a camera application and a navigation application. Such indicators can remind the wearer what applications or processes are presently running and/or consuming power and/or processor resources of the HMD.

Device status indicators 312 can indicate which device(s) are operating on the HMD and HMD status. As shown in FIG. 3, device status indicators 312 include icons for a wireless network and a Bluetooth network, respectively, that indicate the HMD is presently configured for communication via a wireless network and/or a Bluetooth network. In one embodiment, the HMD may not present device status indicators 312 on home card 300.

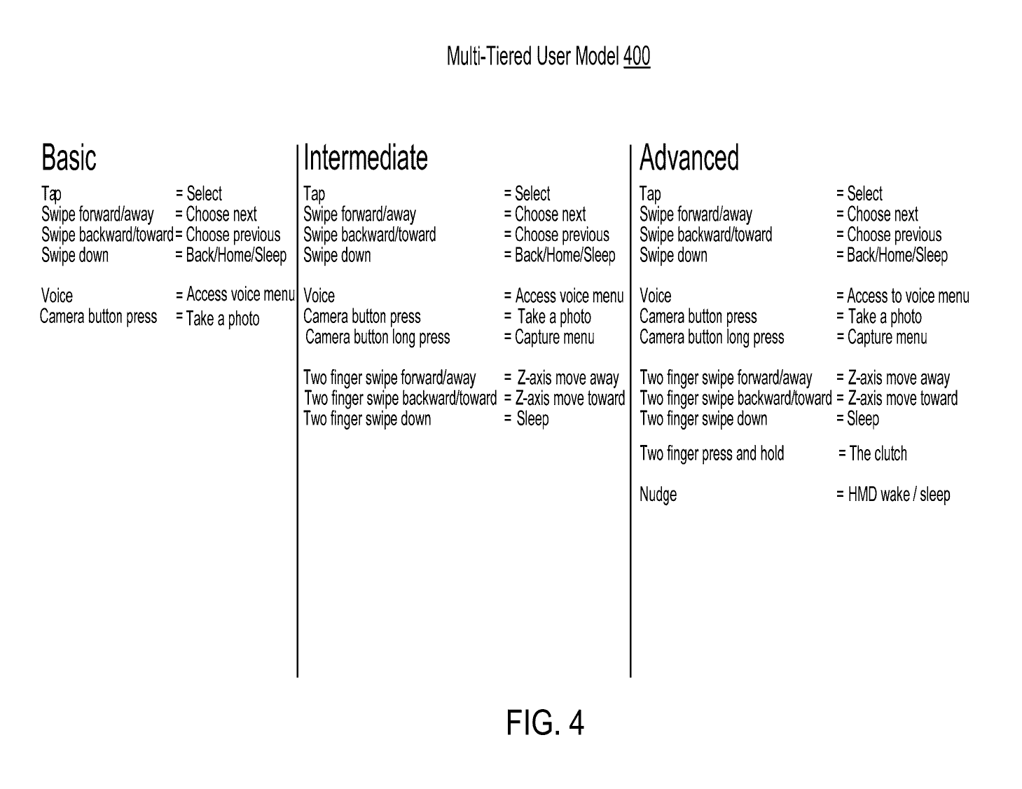

The UI can accept as inputs certain UI operations performed using the touch-based UI. The UI can receive these UI operations and responsively perform actions to enable the wearer to interact with the HMD. These UI operations can be organized into tiers. FIG. 4 lists example UI operations in multi-tiered user model 400 for the HMD, according to an example embodiment.

As shown in FIG. 4, multi-tiered user model 400 has three tiers: basic, intermediate, and advanced. The basic tier provides the smallest number of UI operations of any tier of multi-tiered user model 400. The intermediate tier includes all UI operations provided by the basic tier, along with additional operations not provided by the basic tier. Similarly, the advanced tier includes all UI operations provided by the basic and intermediate tiers, along with additional operations not provided by either the basic tier or intermediate tier.

FIG. 4 shows that the basic tier of multi-tiered user model 400 provides tap, swipe forward, swipe backward, voice, and camera button press operations. A tap operation can involve a single physical tap—that is, one quick, slight strike with one or more fingers on the touch pad of the touch-based UI. A swipe forward operation, sometimes termed a swipe away or a swipe right, can involve a swipe in the general −Z direction; e.g., the direction from the wearer's ear toward the wearer's eye when the wearer has the HMD on. A swipe backward operation, sometimes termed a swipe left or swipe toward, can involve in the general +Z direction; e.g., the direction from the wearer's eye toward the wearer's ear when the wearer has the HMD on. A swipe down operation can involve a downward swipe, where downward is the general direction from the top of the wearer's head toward the wearer's neck when the wearer has the HMD on; e.g., the −Y direction in device coordinate system 250.

While example embodiments in this description make reference to particular directions of touch pad input such as up, down, left, right, it should be understood that these are exemplary and that embodiments where certain operations may be triggered via different input directions are contemplated.

In one embodiment, the physical actions used by the wearer to perform some or all of the herein-described operations can be customized; e.g., by the wearer and/or other entity associated with the HMD. For example, suppose the wearer prefers to perform a physical action of a double-tap—that is, one physical tap quickly followed by a second physical tap—rather than the above-mentioned single physical tap, to perform a tap operation. In this embodiment, the wearer and/or other entity could configure the HMD to recognize a double-tap as a tap operation, such as by training or setting the HMD to associate the double-tap with the tap operation. As another example, suppose that the wearer would like to interchange the physical operations to perform swipe forward and backward operations; e.g., the swipe away operation would be performed using a physical action described above as a swipe left and the swipe toward operation would be performed using a physical action described above as a swipe right. In this embodiment, the wearer could configure the HMD to recognize a physical swipe left as a swipe away operation and physical swipe right as a swipe toward operation. Other customizations are possible as well; e.g., using a sequence of swipes to carry out the tap operation.

The tap operation can select a currently visible card. The swipe away operation can remove the currently visible card from display and select a next card for display. The swipe toward operation can remove the currently visible card from display and select a previous card for display. In other contexts, such as in the context of a Z-axis oriented display, a swipe toward and a swipe away can have different effects, such as, respectively zooming in or zooming out on an image or timeline, increasing or decreasing a settings value, or respectively causing a message to be answered or rejected.

The swipe down operation can, depending on context, act to go back, go home, or sleep. Going back can remove the currently visible card from display and display a previously-visible card for display. For example, the previously-visible card can be the card that was most recently prior currently visible card; e.g., if card A is currently visible and card B is the recently prior currently visible card, then the swipe down operation can remove card A from visibility and display card B. Going home can replace the currently visible card from display and display the home card. Sleeping can cause part; e.g., the display, or all of the HMD to be deactivated.

In some embodiments, a voice operation can provide access to a voice menu of operations. In other embodiments, a camera button press can instruct the HMD to take a photo using a camera associated with and/or part of the HMD. Depending on the state of the HMD, for example when the HMD is displaying an interaction screen associated with a communication application, pressing the camera button may immediately share the photo with a given contact of the HMD.

FIG. 4 shows that the intermediate tier of multi-tiered user model 400 provides tap, swipe forward, swipe backward, voice, and camera button press operations as described above in the context of the basic tier. Also, the intermediate tier provides camera button long press, two finger swipe forward, two finger swipe backward, and two finger swipe down operations.

The camera button long press operation can instruct the HMD to provide a capture menu for display and use. The capture menu can provide one or more operations for using the camera associated with HMD.

In some embodiments, for example when the HMD may be displaying an interaction screen associated with a communication application, the camera long button press can instruct the HMD to immediately begin a “hangout” or video feed with a given contact of the HMD.

In some embodiments, Z-axis oriented movement within an HMD display can be performed by a wearer can swipe toward, swipe away, swipe up, using two fingers on the touch pad of the HMD. For example, a two-finger swipe forward (swipe away) can be interpreted as moving away or decreasing a Z-axis coordinate, and a two-finger swipe backward (swipe toward) can be interpreted as moving toward or increasing the Z-axis coordinate. In some scenarios, a two-finger swipe backward can be used to zoom in on one or more cards and a two-finger swipe forward can be used to zoom out from one or more cards.

The two finger swipe down can cause the HMD to sleep. In some embodiments, the two finger swipe down can save the current position in the timeline for recall and redisplay upon awakening the HMD.

FIG. 4 shows that the advanced tier of multi-tiered user model 400 provides tap, swipe forward, swipe backward, voice, and camera button press operations as described above in the context of the basic tier, as well as camera button long press, two finger swipe forward, two finger swipe backward, and two finger swipe down operations described above in the context of the intermediate tier. The advanced tier also provides one-finger press-and-hold, two-finger press-and-hold, and nudge operations.

The two-finger press-and-hold can provide a “clutch” operation, which can be performed by pressing on the touch-based UI in two separate spots using two fingers and holding the fingers in their respective positions on the touch-based UI. After the fingers are held in position on the touch-based UI, the clutch operation is engaged. In some embodiments, the HMD recognizes the clutch operation only after the fingers are held for at least a threshold period of time; e.g., one second. The clutch operation will stay engaged as long as the two fingers remain on the touch based UI.

The nudge operation can be performed using a short, slight nod of the wearer's head. For example, the HMD can be configured with accelerometers or other motion detectors that can detect the nudge and provide an indication of the nudge to the HMD. Upon receiving indication of a nudge, the HMD can toggle an activation state of the HMD. That is, if the HMD is active (e.g., displaying a card on the activated display) before the nudge, the HMD can deactivate itself (e.g., turn off the display) in response. Alternatively, if the HMD is inactive before the nudge but is active enough to detect nudges; e.g., within two or a few seconds of notification of message arrival, the HMD can activate itself in response.

By way of further example, in one scenario, the HMD is powered on with the display inactive. In response to the HMD receiving a new text message, an audible chime can be emitted by the HMD. Then, if the wearer nudges within a few seconds of the chime, the HMD can activate and present an interaction card or a Z-axis oriented display with the content of the text message. If, from the activated state, if the user nudges again, the display will deactivate. Thus, in this example, the user can interact with the device in a completely hands-free manner.

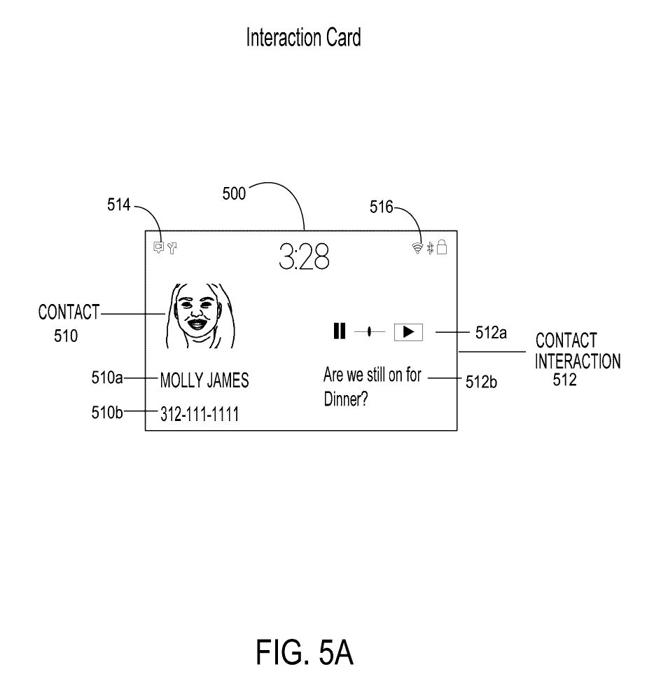

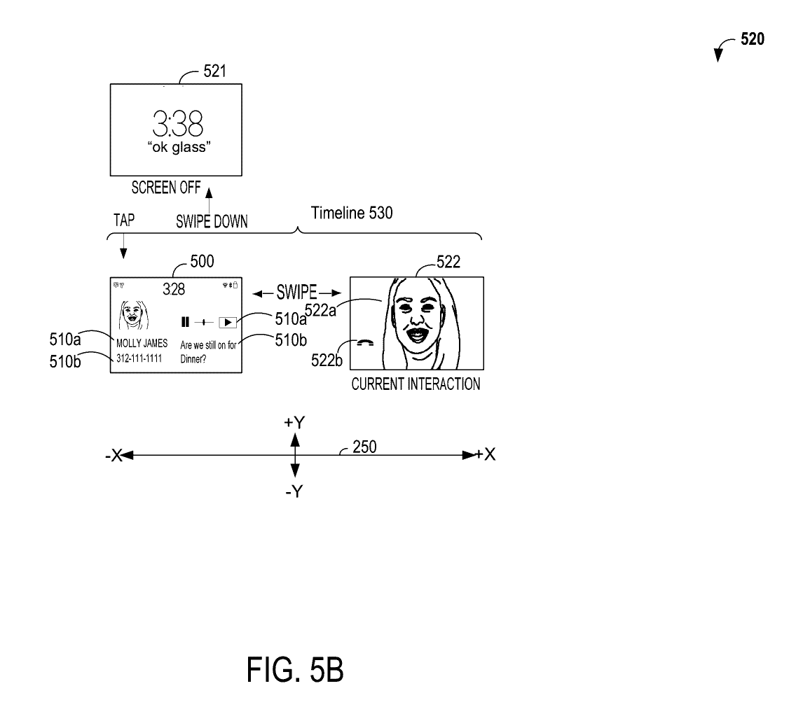

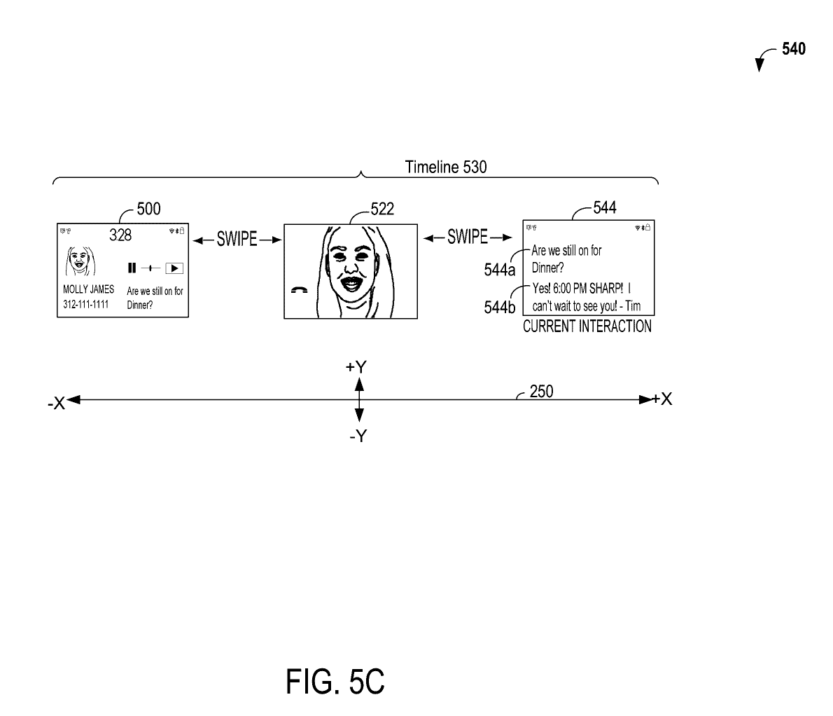

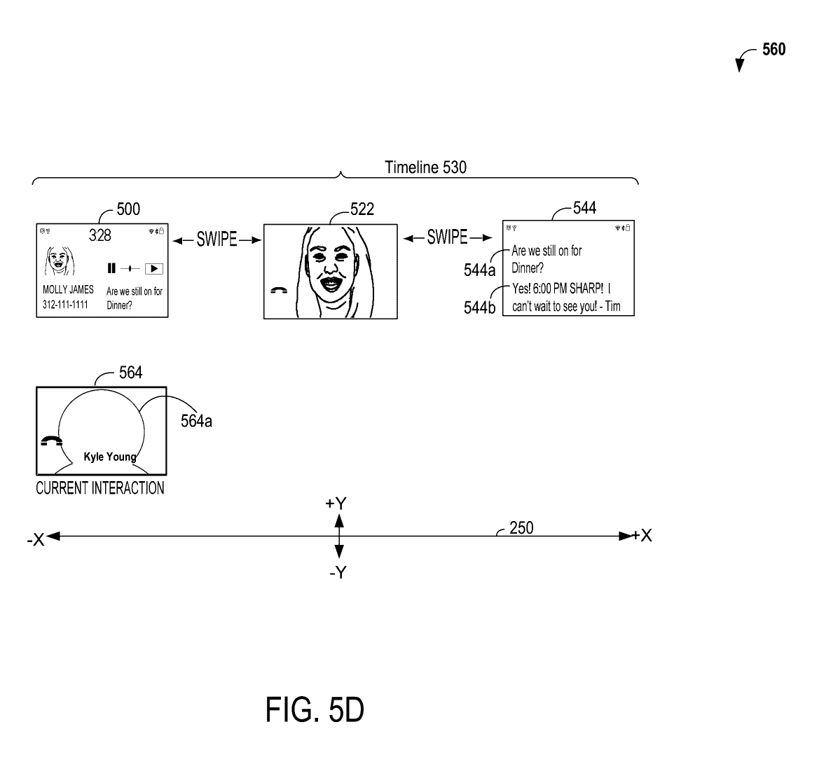

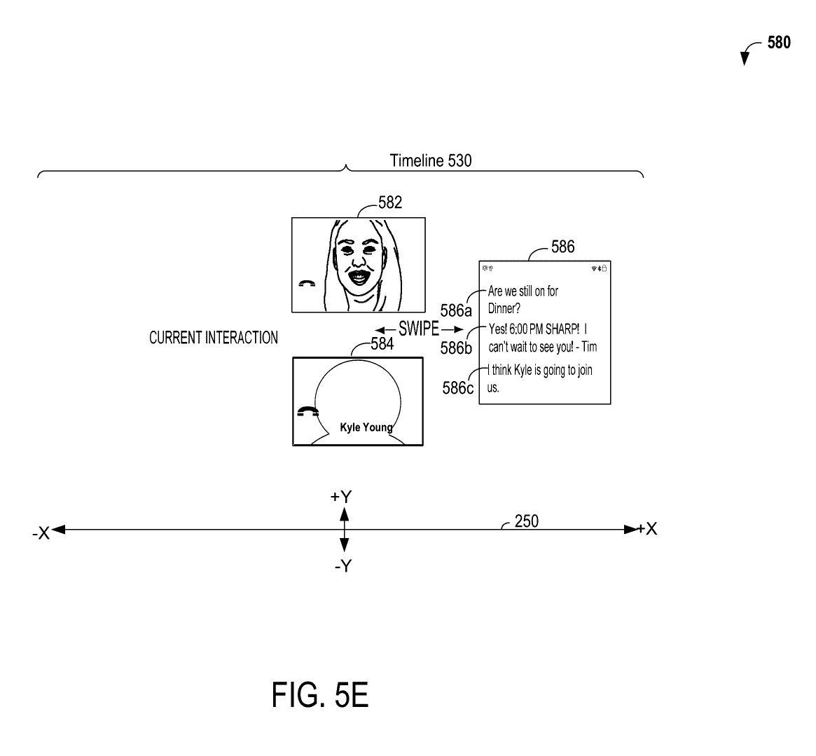

As mentioned above, the UI can maintain a timeline or ordered sequence of cards that can be operated on using the operations described in FIG. 4 immediately above, and may be associated with a certain application, object, or operation. For example, FIG. 5A shows an example interaction card 500, according to an example embodiment. Interaction card 500 may be used, for example, with communication applications associated with the HMD. Such communication applications may include, for example, a messaging application or a video application to name a few. Other communication applications may be used as well.

Interaction card 500 may include details about contacts. FIG. 5A shows example contact details, such as contact icon 510, a contact name 510a and a contact phone number 510b. Additional contact details not shown in FIG. 5A may include, but are not limited to, an email address, a home address, additional phone number(s), a birth date, and website(s); however in other embodiments, more, different or fewer contact details may be included.

Interaction card 500 may also include a contact interaction 512 that includes contact interaction indicators 512a and 512b. The contact interaction indicators may include provide information (or something like that) about a current interaction. For example, in FIG. 5A, interaction indicator 512a may indicate that contact Molly James may have left a voice message for the wearer of the HMD (that may be played using controls provided as a part of interaction indicator 512a), and indicator 512b may be a textual representation of the voice message. Similar to home card 300 shown in FIG. 3, interaction card 500 may also include application status indicators, such as device status indicators 514, 516, and may display a current time, perhaps using a clock shown in large numerals in FIG. 5A.

In some embodiments, the clock may represent a time associated with the interaction rather than the current time. Other indicators may be present on interaction card 500 as well. In some embodiments, interaction card 500 can have more, fewer, or different contact interactions than shown in FIG. 5A. Note the interaction indicators shown in FIG. 5A are examples only and are not intended to be limiting. As such, the indicators may take various other forms as well.

FIG. 5B shows a scenario 520 of an example timeline of interactions for a communication application, according to an example embodiment.

Scenario 520 begins with a home card 521 being displayed by an HMD worn by a wearer. In other examples, scenario 520 may begin with an interaction card, such as the interaction card discussed in the context of at least FIG. 5, or in other examples, scenario 520 may begin with a different interaction card that may relate to another object or application.

The HMD may receive an interaction, indicated in FIG. 5B using current interaction card 522, from a contact associated with the HMD. The contact may be, for example, a contact from the list of contacts associated with the HMD as described above. In FIG. 5B contact 510 shown on interaction card 500 includes an image, and information such as a name and a phone number (contact detail 510a, 510b, respectively). The contact has a name of “Molly James” as indicated by the contact name 510a. Current interaction card 522 may, for example, represent communication(s) such as: a “hangout” or video exchange (e.g., video chat) between the wearer of the HMD and the contact, a text message (e.g., SMS text message) exchanged between the wearer of the HMD and the contact, or an audio exchange (e.g., a telephone call) between the wearer of the HMD and the contact to name a few. In other examples, current interaction card 522 may include a still image, an email message, a social-message notification, or a hyperlink that may have been shared from the contact. Other interactions are possible as well. In some examples, the interaction may include two or more different types of interactions. For example, the wearer of the HMD may receive a voice message from contact Molly James inquiring about dinner reservations and may receive a text transcription of the voice message, as shown in FIG. 5A. The interaction card 500 may be displayed upon receiving the interaction at the HMD.

While the interaction card 500 is being displayed, the wearer of the HMD may receive an input at the HMD. The input may represent a second interaction that is also associated with the contact. Though the second interaction may be different than the first interaction, it too may include one or more of a video exchange, a text message, or an audio message between the wearer of the HMD and the contact. For example, the wearer of the HMD may receive a phone call from Molly James, as she continues to attempt to confirm dinner plans. A second interaction screen may be generated on the HMD. FIG. 5B shows the second interaction card 522, which may include an image representing a face of Molly James 522a as well as a phone call indicator 522b indicating that Molly James called.

The HMD may associate current interaction card 522 with the ordered plurality of interaction card shown on timeline 530, or in this example, associate second interaction screen 522 with first interaction screen 500. Second interaction screen 522 may be associated in a manner such that first interaction screen 500 is subsequent to second interaction screen 522 in the order. Accordingly, second interaction screen 522 may be indicative of the most recent interaction between the wearer of the HMD and the contact (shown as current interaction in FIG. 5B). Once the second interaction screen 522 has been associated, it may be displayed using the HMD. In some embodiments a portion of the interaction screens may overlap each other with the interactions screen on top representing the most recent interaction.

When displayed, the interaction screen 500 may be arranged as a part of a timeline or ordered plurality of interaction screens 500-522 (shown in FIG. 5B) that are indicative of an interaction history (or communication history) associated with the contact. In some examples, the most current interaction screen may be laid over previous interaction screens.

As shown in FIG. 5B, interaction screen 500 and interaction screens 522 can be arranged as a “timeline” or ordered sequence of cards based on time. FIG. 5B shows that cards 500 and 522 are arranged along the X-axis of device coordinate system 250. In the example shown in FIG. 5B, each card in timeline 530 has a specific time associated with the card (although each card may not display the specific time).

Timeline 530 can be ordered along the X-axis based on the specific time associated with each card. In some cases, the specific time can be “now” or the current time. For example, home card 521 and/current interaction card 522 can be associated with the specific time of now. In other cases, the time can be a time associated with an event leading to the card. For example, FIG. 5B shows that card 500 represents a time of 3:28. As the specific time of interaction card 522 is later than 3:28, the time associated with interaction card 500 is shown having a smaller X component in device coordinate system 250 than interaction card 522.

In scenario 520, the HMD can enable navigation of time line 530 using swipe operations. For example, starting at interaction card 522, a swipe backward operation can cause the HMD to select and display a previous card, such as card 500, and a swipe forward operation the HMD to select and display a next card if there were one. Upon displaying card 500, the swipe forward operation can cause the HMD to select and display the previous card, which is interaction card 522.

In scenario 520, there are no cards in timeline 530 that are previous to interaction card 500. In one embodiment, the timeline is represented as circular. For example, in response to a swipe backward operation on card 500 requesting a previous card for display, the HMD can select 522 for (re)display, as there are no cards in timeline 530 that are after card 500 during scenario 500. Similarly, in response to a swipe forward operation on card 522 requesting a next card for display, the HMD can select 500 for (re)display, as there are no cards in timeline 530 that are after card 522 during scenario 520.

In another embodiment, instead of a circular representation of the timeline, when the user navigates to the end of the timeline, a notification is generated to indicate to the user that there are no additional cards to navigate to in the instructed direction. Examples of such notifications could include any of or a combination of any of a visual effect, an audible effect, a glowing effect on the edge of the card, a three dimensional animation twisting the edge of the card, a sound (e.g. a click), a textual or audible message indicating that the end of the timeline has been reached (e.g. “there are no cards older than this”). Alternatively, in one embodiment, an attempt by the user to navigate past a card in a direction where there are no additional cards could result in no effect, i.e. swiping right on card 522 results in no perceptible change to the display or card 522.

Alternatively, in some embodiments, a Z-axis oriented display may be used to display the interaction cards. Using the Z-axis display a wearer may, for example, simulate bringing the most current interaction card closer (in the Z dimension), while decreasing a size of an interaction card can simulate moving away from the object (in the Z dimension).

In another embodiment, instead of receiving an input at the HMD (e.g., from a contact) a wearer of the HMD may provide input at the HMD to initiate an interaction with the contact of the HMD. FIG. 5C shows such a scenario 540. Scenario 540 begins with a wearer of the HMD providing an input to the HMD. The input to the HMD may be different than the input received at the HMD from the contact, but may also include interactions such as a telephone call or text message. In scenario 540, the input may be a text message that confirms the dinner plans. The input may be input via any of the input means discussed above in the context of at least FIGS. 1-2, for example.

After providing the input, an interaction screen 544 may be associated with the ordered plurality of interaction screens, or as shown in FIG. 5C, associated with interaction screens 500 and 522. Similar to interaction card 522 in scenario 520 the interaction screen may be placed at the front of the ordered plurality of screens thereby representing the most recent interaction (current interaction) of the interaction history. Once the interaction screen has been properly associated it may be displayed on the HMD in a manner such as described in the context of at least FIGS. 5A and 5B.

Shown in FIG. 5C, interaction screen 544 may include a transcription 544a of the original text message (interaction indicator) from Molly James and a response text message 544b from the wearer of the HMD. Interaction screen 544 may also include the application status indicators, as shown at the top of interaction screen 544.

In another embodiment, while an interaction screen is being displayed (e.g., interaction screen 522), the HMD may receive input from a second contact or different contact than the first contact (i.e., the contact the wearer was originally communicating with). The second contact may also be, for example, a contact from the list of contacts associated with the HMD. FIG. 5D illustrates such an embodiment. In FIG. 5D, a second contact “Kyle Young” has interacted with the wearer of the HMD via telephone (as indicated by the telephone indicator). In this embodiment, the image 564a associated with Kyle Young is not an image of Kyle, but a default or otherwise previously selected image. The input may be similar to the inputs noted above and may represent an interaction between the wearer of the device and the second contact. FIG. 5D shows the interaction screen displayed along timeline 530 and below the interaction screens representing the interactions (or communication history) between the wearer of the HMD and contact Molly James. In other examples, the interaction screen representing the interaction between Kyle Young and the wearer of the HMD may be displayed in its own timeline.

In yet further embodiments, the input may represent an interaction between the wearer of the HMD, the second contact, and the original contact. Upon receiving the interaction, the HMD may display a plurality of interaction screens in a manner that associates the second contact with the wearer of the HMD, as discussed above, but also associates the second contact with the first contact. FIG. 5E shows, for example, interaction screens 582, 584, and 586 that represent an interaction between the wearer of the HMD and multiple contacts. Interaction screens 582 and 584 may indicate, for example, that the wearer of the HMD held a conference type telephone conversation with both Molly James and Kyle Young, and interaction screen 586 may represent the text messages 586a, 586b, and 586c shared between Molly James, the wearer of the HMD, and Kyle Young. FIG. 5E shows that Kyle Young is now inquiring as to whether he can attend the dinner the wearer of the HMD and Molly James were discussing earlier (as shown in FIG. 5B). Accordingly, the interaction screens may represent, for example, a new timeline of communication between the first contact, the second contact, and the wearer of the HMD. The interaction screens may be included in the timeline between the first contact and the wearer of the HMD as described, for example, in the context of FIGS. 5A-5C.

In other embodiments, the interaction screens (e.g., interaction screen 500, 522, 584. 586) may not be different interaction screens arranged on a timeline, but may instead all be represented by one interaction screen. In other words, instead of having multiple interaction cards displayed along a timeline that correspond to the history of communication (or interactions) between the wearer of the HMD and one or more contacts, the entire history of communication may be represented by one interaction screen that may update or change whenever a new interaction or communication is received. As such, each participant of the communication can initiate a new interaction (or communication) thereby updating the interaction screen to include the most recent communication.

### E. EXAMPLE METHODS OF OPERATION

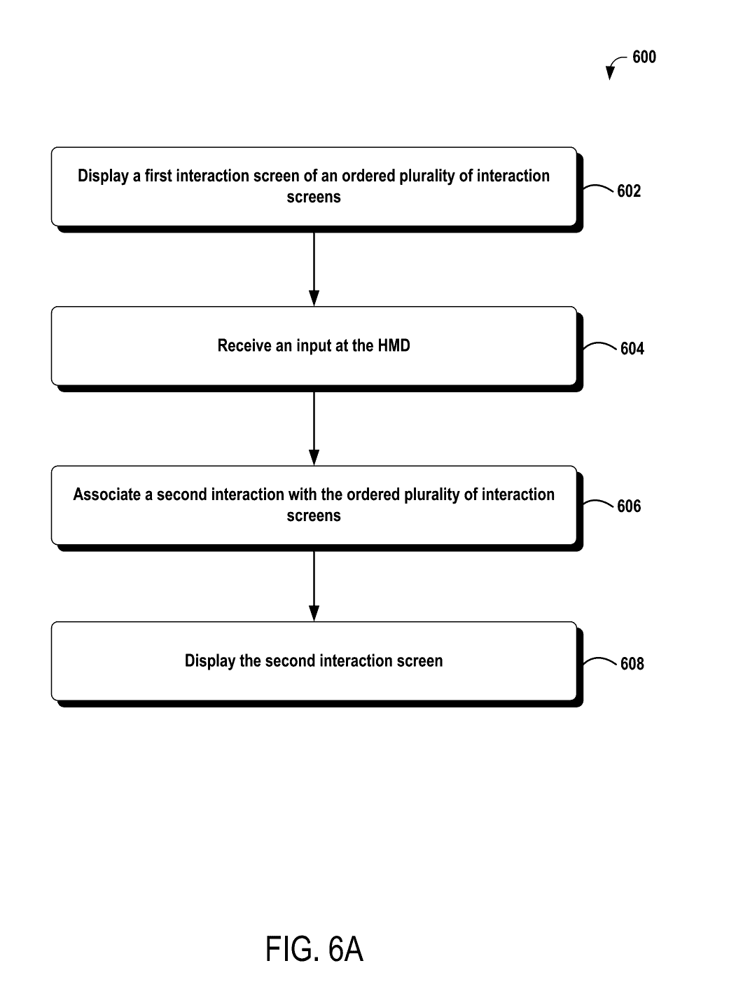

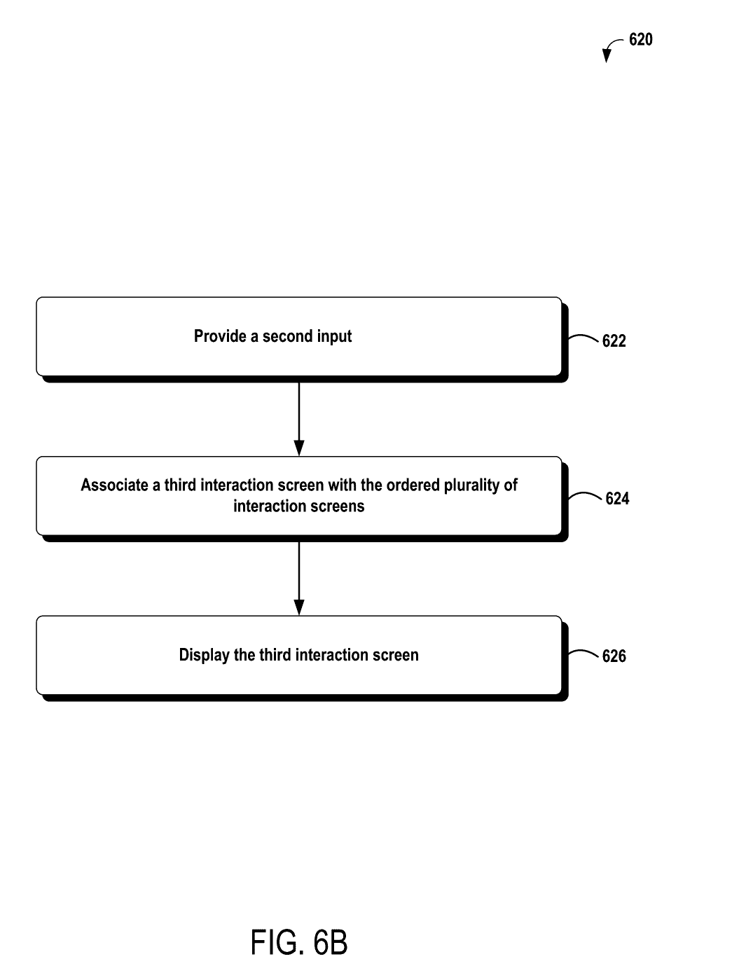

FIG. 6A is a flow chart illustrating method 600, according to an example embodiment. In FIG. 6A, method 600 is described by way of example as being carried out by a wearable computer and possibly a wearable computer embodied as a HMD; e.g., HMD 260. However, it should be understood that example methods, such as method 600, may be carried out by a wearable computer without wearing the computer. For example, such methods may be carried out by simply holding the wearable computer using the wearer's hands. Other possibilities may also exist.

Further, example methods, such as method 600, may be carried out by devices other than a wearable computer, and/or may be carried out by sub-systems in a wearable computer or in other devices. For example, an example method may alternatively be carried out by a device such as a mobile phone, which is programmed to simultaneously display a graphic object in a graphic display and also provide a point-of-view video feed in a physical-world window. Other examples are also possible.

As shown in FIG. 6A, method 600 begins at block 602 where an HMD can display a first interaction screen of an ordered plurality of interaction screens, such as discussed above in the context of at least FIGS. 5A-5C. The ordered plurality of interaction screens may be indicative of an interaction history associated with a contact of the HMD, such as Molly James discussed in the context of FIGS. 5A-5C.

At block 604, while displaying the interaction screen, the HMD can receive an input at the HMD such as discussed above in the context of at least FIGS. 5A-5C.

At block 606, the HMD can associate the second interaction with the ordered plurality of interaction screens such as discussed in the context of at least FIGS. 5B-5C. Alternatively, interaction cards can be arranged by a different order other than the time-based order used by the timeline. For example, a list of interaction cards can be arranged by interaction type. Other orderings may be possible as well.

At block 608, the HMD can display the second interaction screen such as discussed in the context of at least FIGS. 5A-5C.

FIG. 6B is another flow chart illustrating a method 620, according to an example embodiment. Similar to method 600 in FIG. 6B, method 620 is described by way of example as being carried out by a wearable computer embodied as a HMD; e.g., HMD 260. Method 620 may be carried out in addition to method 600. In particular, method 620 may provide for the wearer of HMD 260 to provide input to the HMD himself/herself thereby creating a new interaction. In other words, in addition to receiving interactions at the HMD from a contact, the HMD may initiate interactions as well.

Method 620 begins a block 622 where an HMD can provide a second input to the HMD. The input may be provided in a manner such as discussed in at least the context of FIG. 5C.

At block 624, the HMD can associate a third interaction screen with the ordered plurality of interaction screens such as discussed in at least the context of FIGS. 5A-5C. Similar to method 600, interaction cards can be arranged by a different order other than the time-based order used by the timeline. For example, a list of interaction cards can be arranged by interaction type. Other orderings may be possible as well.

At block 626, the HMD can display the third interaction screen. The third interaction screen may be displayed such as in the context of at least FIGS. 5A-5C.

### F. CONCLUSION

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
at a head-mountable device (HMD), displaying a first interaction screen that is part of a timeline interaction interface comprising an ordered plurality of interaction screens, wherein the first interaction screen comprises information corresponding to a first interaction associated with a first contact of a user-account associated with the HMD, wherein the timeline interaction interface is associated with one or more contacts comprising at least the first contact, and wherein the ordered plurality of interaction screens are navigable in a linear fashion via touch input on a touch pad of the HMD;
while displaying the first interaction screen of the timeline interaction interface, detecting a tap-and-hold input via the touch pad;
in response to detecting initiation of the tap-and-hold input:
(i) initiating a further interaction with the one or more contacts that are associated with the timeline interaction interface, wherein initiating the interaction comprises adding a second interaction screen to the timeline interaction interface and displaying the second interaction screen using the HMD, wherein the tap-and-hold input continues after display of the second interaction screen;
(ii) during the tap-and-hold input, receiving a second interaction comprising voice input, via at least one microphone of the HMD; and
(iii) during a time period when the voice input is being received:
(a) applying a speech-to-text process to generate a real-time text transcription of the voice input;
(b) updating, in real-time, the display of the second interaction screen to include the text transcription of the voice input; and
(c) sending, in real-time, the transcription of the voice input to the one or more contacts that are associated with the timeline interaction interface to facilitate real-time display of the text transcription in a corresponding version of the second interaction screen at a computing device of at least one of the associated contacts at which the timeline interaction interface is also being displayed.

2. The method of claim 1,
wherein the first interaction further comprises at least one of the following items: a first video feed, a first text message, a first still image, a first telephone call, a first email message, a first social-message notification, or a first hyperlink, and
wherein the second interaction comprises at least one of a second video feed, a second text message, a second still image, a second telephone call, a second email message, a second social-message notification, or a second hyperlink.

3. The method of claim 1, wherein the ordered plurality of interaction screens are ordered based on time, and wherein each interaction screen in the ordered plurality of interaction screens is associated with a specific time.

4. (canceled)

5. The method of claim 1, further comprising:
after completing the sending of the transcription of the voice input to the one or more contacts that are associated with the timeline interaction, and while displaying the second interaction screen:
providing a second input at the HMD, wherein the second input is associated with the at least one contact and comprises a third interaction, wherein the third interaction is different than the first interaction and the second interaction;
associating a third interaction screen with the ordered plurality of interaction screens, wherein the third interaction screen comprises information corresponding to the third interaction, wherein the third interaction screen is subsequent to the second interaction screen in the ordered plurality of interaction screens, and wherein the third interaction is indicative of the most recent interaction in the interaction history; and
displaying the third interaction screen using the HMD.

6. The method of claim 5, wherein the third interaction comprises at least one of a video feed, a text message, a still image, a telephone call, an email message, a social-message notification, or a hyperlink.

7. (canceled)

8. (canceled)

9. A head-mountable device (HMD), comprising:
a display;
a processor; and
a non-transitory computer-readable storage medium having stored thereon program instructions that, upon execution by the processor, cause the HMD to perform functions comprising:
displaying a first interaction screen that is part of a timeline interaction interface comprising an ordered plurality of interaction screens, wherein the first interaction screen comprises information corresponding to a first interaction associated with a first contact of a user-account associated with the HMD, wherein the timeline interaction interface is associated with one or more contacts comprising at least the first contact, and wherein the ordered plurality of interaction screens are navigable in a linear fashion via touch input on a touch pad of the HMD;
while displaying the first interaction screen of the timeline interaction interface, detecting a tap-and-hold input via the touch pad;
in response to detecting initiation of the tap-and-hold input:
(i) initiating a further interaction with the one or more contacts that are associated with the timeline interaction interface, wherein initiating the interaction comprises adding a second interaction screen to the timeline interaction interface and displaying the second interaction screen using the HMD, wherein the tap-and-hold input continues after display of the second interaction screen;
(ii) during the tap-and-hold input, receiving a second interaction comprising voice input, via at least one microphone of the HMD; and
(iii) during a time period when the voice input is being received: (a) applying a speech-to-text process to generate a real-time text transcription of the voice input; (b) updating, in real-time, the display of the second interaction screen to include the text transcription of the voice input; and (c) sending, in real-time, the transcription of the voice input to the one or more contacts that are associated with the timeline interaction interface to facilitate display of the text transcription in a corresponding version of the second interaction screen at a computing device of at least one of the associated contacts at which the timeline interaction interface is also being displayed.

10. The HMD of claim 9,
wherein the first interaction further comprises at least one of the following items: a first video feed, a first text message, a first still image, a first telephone call, a first email message, a first social-message notification, or a first hyperlink, and
wherein the second interaction comprises at least one of a second video feed, a second text message, a second still image, a second telephone call, a second email message, a second social-message notification, or a second hyperlink.

11. The HMD of claim 9, wherein the ordered plurality of interaction screens are ordered based on time, and wherein each interaction screen in the ordered plurality of interaction screens is associated with a specific time.

12. (canceled)

13. (canceled)

14. (canceled)

15. An apparatus, including a non-transitory computer-readable storage medium having stored thereon program instructions that, upon execution by a computing device, cause the apparatus to perform functions comprising:
displaying a first interaction screen that is part of a timeline interaction interface comprising an ordered plurality of interaction screens, wherein the first interaction screen comprises information corresponding to a first interaction associated with a first contact of a user-account associated with the HMD, wherein the timeline interaction interface is associated with one or more contacts comprising at least the first contact, and wherein the ordered plurality of interaction screens are navigable in a linear fashion via touch input on a touch pad of the HMD;
while displaying the first interaction screen of the timeline interaction interface, detecting a tap-and-hold input via the touch pad;
in response to detecting initiation of the tap-and-hold input:
(i) initiating a further interaction with the one or more contacts that are associated with the timeline interaction interface, wherein initiating the interaction comprises adding a second interaction screen to the timeline interaction interface and displaying the second interaction screen using the HMD, wherein the tap-and-hold input continues after display of the second interaction screen;
(ii) during the tap-and-hold input, receiving a second interaction comprising voice input, via at least one microphone of the HMD; and
(iii) during a time period when the voice input is being received:
(a) applying a speech-to-text process to generate a real-time text transcription of the voice input;
(b) updating, in real-time, the display of the second interaction screen to include the text transcription of the voice input; and
(c) sending, in real-time, the transcription of the voice input to the one or more contacts that are associated with the timeline interaction interface to facilitate real-time display of the text transcription in a corresponding version of the second interaction screen at a computing device of at least one of the associated contacts at which the timeline interaction interface is also being displayed.

16. The apparatus of claim 15,
wherein the first interaction further comprises at least one of the following items: a first video feed, a first text message, a first still image, a first telephone call, a first email message, a first social-message notification, or a first hyperlink, and
wherein the second interaction comprises at least one of a second video feed, a second text message, a second still image, a second telephone call, a second email message, a second social-message notification, or a second hyperlink.

17. The apparatus of claim 15, wherein the ordered plurality of interaction screens are ordered based on time, and wherein each interaction screen in the ordered plurality of interaction screens is associated with a specific time.

18. (canceled)

19. (canceled)

20. (canceled)

21. The method of claim 1, further comprising, while displaying the first interaction screen:
receiving input data corresponding to a camera button press; and
in response to the camera button press carrying out all of the following operations: (a) operating a camera of the HMD to take a photo, (b) adding a third interaction screen to the timeline interaction interface, wherein the third interaction screen comprises information corresponding to the photo, and (c) sending the photo to the one or more other contacts that are associated timeline interaction interface to facilitate display of the third interaction screen at a computing device, of at least one of the associated contacts, at which the timeline interaction interface is also being displayed.

22. The method of claim 1, further comprising in response to an end of the tap-and-hold input:
updating the display of the second interaction screen at the HMD to include graphic audio player feature that provides controls to play an audio file of the voice input that was received during the tap-and-hold input, wherein the text transcription displayed in the corresponding version of the second interaction screen comprises a complete transcription of the voice input; and
sending audio-file information that corresponds to the audio file of the voice input, to the one or more contacts that are associated with the timeline interaction interface to facilitate display of the graphic audio player feature in the second interaction screen at the computing device of at least one of the associated contacts.

23. The method of claim 1, further comprising, as a further response to detecting initiation of the tap-and-hold input:
upon detecting an end of the tap-and-hold input: (a) updating the display of the second interaction screen at the HMD to include graphic audio player feature that provides controls to play an audio file of the voice input that was received during the tap-and-hold input, wherein the text transcription displayed in the corresponding version of the second interaction screen comprises a complete transcription of the voice input, and (b) sending audio-file information that corresponds to the audio file of the voice input, to the one or more contacts that are associated with the timeline interaction interface to facilitate display of the graphic audio player feature in the second interaction screen at the computing device of at least one of the associated contacts.
